(19) United States
(12) Patent Application Publication
(10) Pub. No.: US 2022/0222586 A1
(43) Pub. Date: Jul. 14, 2022

(54) RECORDING MEDIUM, INFORMATION PROCESSING METHOD, AND INFORMATION PROCESSING APPARATUS

(71) Applicant: FUJITSU LIMITED, Kawasaki-shi (JP)

(72) Inventor: Satoru KODA, Kawasaki (JP)

(73) Assignee: FUJITSU LIMITED, Kawasaki-shi (JP)

(21) Appl. No.: 17/707,976

(22) Filed: Mar. 30, 2022

Related U.S. Application Data
(63) Continuation of application No. PCT/JP2019/039499, filed on Oct. 7, 2019.

(51) Int. Cl. G06N 20/10; G06N 3/08; G06N 3/04

(52) U.S. Cl. CPC G06N 20/10; G06N 3/04; G06N 3/08

(57) ABSTRACT

A non-transitory computer-readable recording medium stores an information processing program. The information processing program causes a computer to execute a process including identifying feature amounts for respective values in categorical data so as to minimize a third loss function based on a first loss function for extraction of feature amounts in categorical data and a second loss function for detection of abnormal values in the categorical data, and detecting the abnormal values in the categorical data, based on the feature amounts identified for the respective values in the categorical data.

### CROSS-REFERENCE TO RELATED APPLICATION

This application is a continuation application of International Application PCT/JP2019/039499, filed on Oct. 7, 2019 and designating the U.S., the entire contents of which are incorporated herein by reference.

### FIELD

The embodiment discussed herein is related to an information processing program, an information processing method, and an information processing apparatus.

### BACKGROUND

Conventional technologies have been present for detecting abnormal values in categorical data. Herein, categorical data refers to data in which values are discrete. Examples of categorical data include internet protocol (IP) addresses, port numbers, and host names. By detecting an abnormal value in a source IP address as an anomaly IP address, unauthorized access can be detected.

FIG. 10 is a diagram illustrating a flow of anomaly IP address detection. As illustrated in FIG. 10, an apparatus for detecting an anomaly IP address extracts feature amounts of source IP addresses from a communication log and conducts machine training by using the extracted feature amounts, thereby detecting an anomaly IP address.

A communication log includes Src. IP, Dst. IP, Dst. Port, and host. Src. IP refers to a source IP address. Dst. IP refers to a destination IP address. Dst. Port refers to a destination port number. host refers to a place where the communication log is obtained. The feature is, for example, whether a specific source IP address is included. If the address is included, the feature amount is “1”, and, if not, the feature amount is “0”.

In a case in which feature amounts of source IP addresses are extracted, the communication log has enormous patterns, causing the feature amount vector of the source IP addresses to have a high dimension reaching several hundred thousand dimensions, which makes machine training inefficient.

Thus, IP2Vec exists as a technology for extracting low-dimensional feature amount vectors. In IP2Vec, feature amounts of IP addresses are extracted based on co-occurrence patterns. FIG. 11 is a diagram for explaining IP2Vec. In FIG. 11, the source IP address “IP1” co-occurs with the destination IP address “10.***.2”, the destination IP address “10.***.3”, the destination port number “22”, and the destination port number “3389” in the communication log.

In IP2Vec, feature vectors of IP addresses are extracted by applying Word2Vec to extract feature vectors of words on the basis of word co-occurrence. Because an anomaly IP address and a normal IP address have different co-occurrence patterns of destination IP addresses and destination port numbers from each other, an abnormal feature amount is extracted for the anomaly IP address.

As a conventional technology for analyzing an abnormality in a network, a communication analysis apparatus has been present that, when detecting an abnormality on a network, is capable of determining the content of abnormality. This communication analysis apparatus has a plurality of abnormality detection units that detect the degree of an abnormality of the network from information generated in a network device. The communication analysis apparatus also has a feature amount generation unit that generates, for each of the abnormality detection units, a feature amount to be supplied to the abnormality detection unit from the information generated by the network device. The communication analysis apparatus also has a detection result management unit that manages management information obtained by summing up detection results detected by each of the abnormality detection units on the basis of the feature amount. The communication analysis apparatus also has: a determination unit that performs a determination process of determining the content of an abnormality that has occurred on the network on the basis of the management information managed by the detection result management unit; and an output unit that outputs determination result information indicating the result of the determination process.

Patent Literature 1: Japanese Laid-open Patent Publication No. 2019-80201

Non Patent Literature 1: Ring, Markus, et al. “IP2Vec: Learning Similarities between IP Addresses.”, 2017 IEEE International Conference on Data Mining Workshops (ICDMW), IEEE, 2017.

### SUMMARY

According to an aspect of the embodiments, a non-transitory computer-readable recording medium stores an information processing program that causes a computer to execute a process including: identifying feature amounts for respective values in categorical data so as to minimize a third loss function based on a first loss function for extraction of feature amounts in categorical data and a second loss function for detection of abnormal values in the categorical data; and detecting the abnormal values in the categorical data, based on the feature amounts identified for the respective values in the categorical data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a functional configuration of an anomaly detection apparatus according to an embodiment.

FIG. 2 is a diagram illustrating an example encoding of logs.

FIG. 3 is a diagram for explaining generation of feature amounts by a feature amount generation unit.

FIG. 4A is a diagram illustrating definitions of symbols for IP2Vec.

FIG. 4B is a diagram illustrating definitions of symbols for SVDD.

FIG. 5 is a flowchart illustrating a flow of a process performed by the anomaly detection apparatus.

FIG. 6 is a diagram illustrating a flow of a process of computing anomaly scores by generating feature amounts that minimize L.

FIG. 7 is a diagram for explaining effective feature amounts generated by the anomaly detection apparatus.

FIG. 8 is a diagram illustrating the effect of the anomaly detection apparatus.

FIG. 9 is a diagram illustrating a hardware configuration of a computer that executes an anomaly detection program according to the embodiment.

FIG. 10 is a diagram illustrating a flow of anomaly IP address detection.

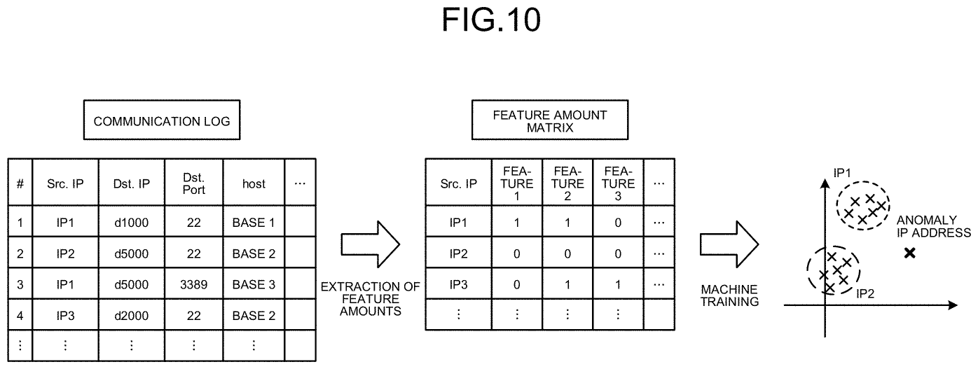

FIG. 11 is a diagram for explaining IP2Vec.

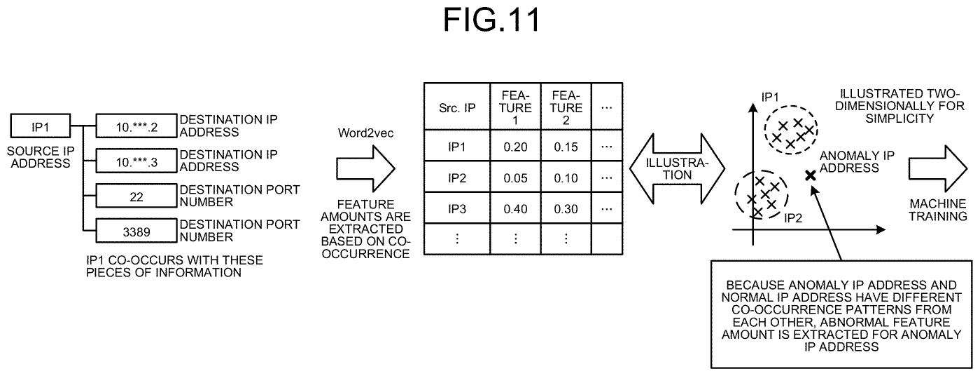

### DESCRIPTION OF EMBODIMENTS

Conventional anomaly detection performs feature extraction and detection at independent steps. Consequently, a feature amount effective for detection is not capable of being extracted at the feature extraction step, and detection precision is problematically low. Herein, a feature amount effective for detection refers to such a feature amount that the separation boundary between normal and anomaly is noticeable in a feature amount space.

Accordingly, the embodiments provide an information processing program, an information processing method, and an information processing apparatus that improve the precision of anomaly detection.

Preferred embodiments of an information processing program, an information processing method, and an information processing apparatus of the present invention will be explained in detail below with reference to accompanying drawings. The embodiments are not intended to limit the disclosed technology.

### Embodiment

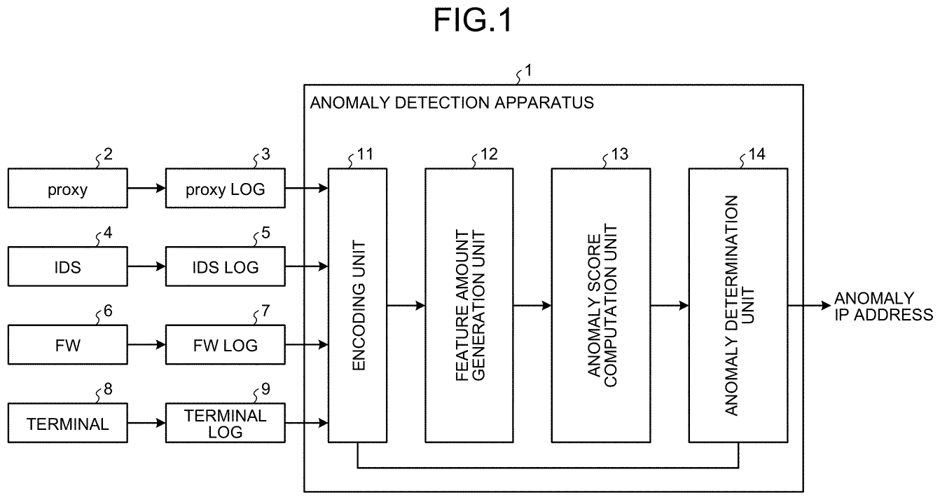

A functional configuration of an anomaly detection apparatus according to an embodiment will be explained first. FIG. 1 is a diagram illustrating the functional configuration of the anomaly detection apparatus according to the embodiment. As illustrated in FIG. 1, an anomaly detection apparatus 1 according to the embodiment has an encoding unit 11, a feature amount generation unit 12, an anomaly score computation unit 13, and an anomaly determination unit 14.

The encoding unit 11 receives a proxy log 3 from a proxy 2, receives an intrusion detection system (IDS) log 5 from an IDS 4, receives a firewall (FW) log 7 from FW 6, and receives a terminal log 9 from a terminal 8. The encoding unit 11 may receive other communication logs from other devices.

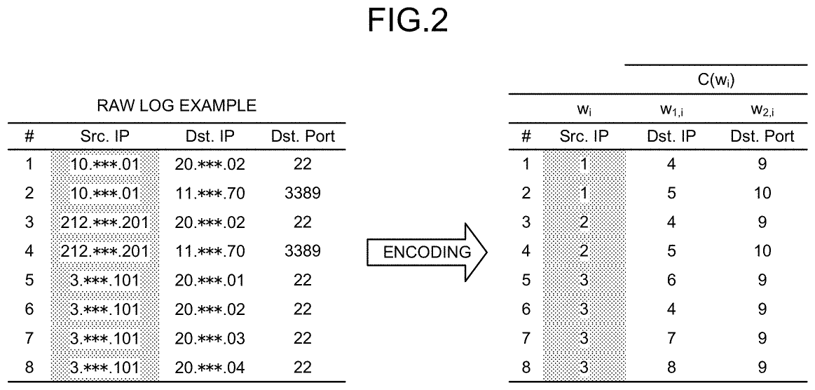

The encoding unit 11 then encodes these logs. FIG. 2 is a diagram illustrating an example encoding of logs. In FIG. 2, Src. IP refers to a source IP address, Dst. IP refers to a destination IP address, and Dst Port refers to a destination port number. i represents the log number, and, in this example, the total number of logs N=8. wᵢ represents the source IP address of the i-th log. C(wᵢ)={w_{1,i}, . . . , w_{c,i}} represents communication information of the i-th log, and c represents the number of pieces of information constituting the communication information of wᵢ. In this example, c=2, w_{1,i} is Dst. IP, and w_{2,i} is Dst. Port.

As illustrated in FIG. 2, the Src. IP “10.***.01” is encoded into “1”, the Src. IP “212.***.201” is encoded into “2”, and the Src. IP “3.***.101” is encoded into “3”. Also, the Dst. IP “20.***.02” is encoded into “4”, the Dst. IP “11.***.70” is encoded into “5”, and the Dst. IP “20.***.01” is encoded into “6”. Also, the Dst. IP “20.***.03” is encoded into “7”, and the Dst. IP “20.***.04” is encoded into “8”. Also, the Dst. Port “22” is encoded into “9”, and the Dst. Port “3389” is encoded into “10”.

The feature amount generation unit 12 receives an encoding result encoded by the encoding unit 11, and generates a feature amount of the source IP address. The feature amount generation unit 12 generates a feature amount that minimizes

a loss function L=L_{extraction}+λL_{detection}.

Herein, L_{extraction} is a loss function for feature extraction, and L_{detection} is a loss function for anomaly detection. λ represents the coefficient for adjusting a trade-off between the loss function for feature extraction and the loss function for anomaly detection. An inequality λ>0 holds.

For example, in a case in which IP2Vec is used to extract a feature amount of a source IP address, L_{extraction} is defined by the following expression (1).

$$Expression 1$$

$${L}_{extracti} , {U}^{′} ) = - {\sum }_{i} {\sum }_{c} log P ( {w}_{c , i} \vert {w}_{i} ; U , {U}^{′} ) \qquad ( 1 )$$

Herein, U and U′ respectively represent a weighting matrix from an input layer to a hidden layer and a weighting matrix from the hidden layer to a final layer in IP2Vec. P(w_{c,i}|wᵢ; U, U′) represents the posterior probability that, when wᵢ is determined, w_{c,i} co-occur.

For example, in a case in which support vector data description (SVDD) is used to perform anomaly detection, L_{detection} is defined by the following expression (2).

$$Expression 2$$

$${L}_{d e t e c t i} {c}_{0} ) = {\sum }_{j} {‖ ϕ ( {h}_{j} ) - {c}_{0} ‖}_{2}^{2} \qquad ( 2 )$$

Herein, φ represents an arbitrary map, c₀ represents a point in a mapping space H, and hⱼ represents a feature amount of a source IP address j. c₀ and hⱼ are vectors. In expressions and drawings, vectors such as c₀ and hⱼ appear in boldface, while, in the rest, boldface is not used. ∥φ(hⱼ)−c₀∥₂ represents the L₂ norm of φ(hⱼ)−c₀.

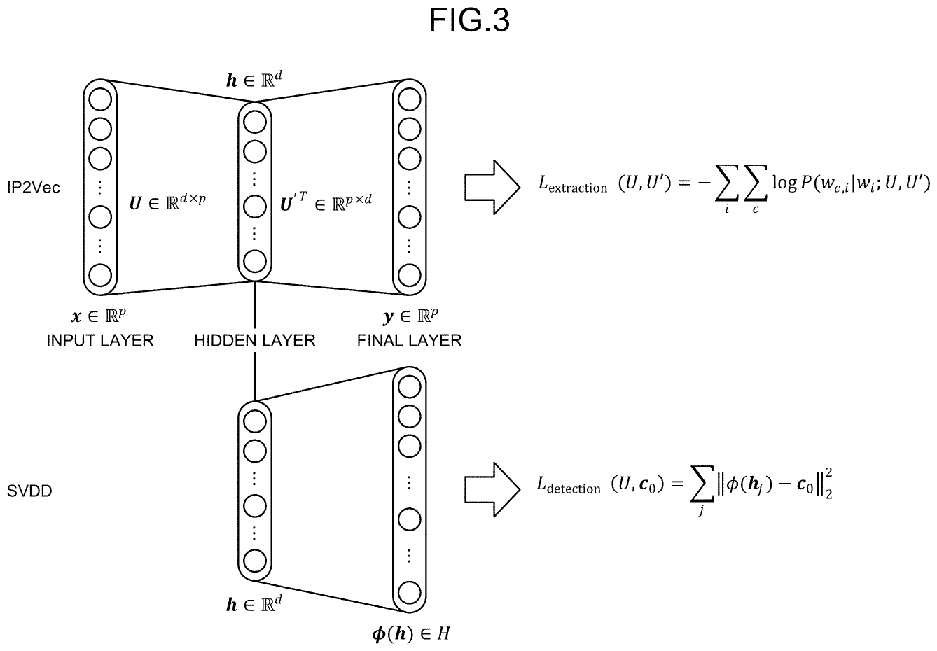

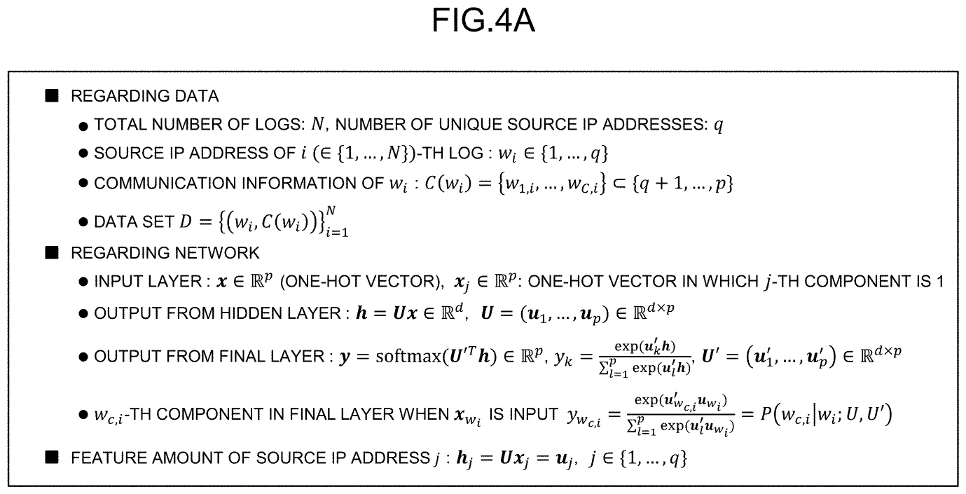

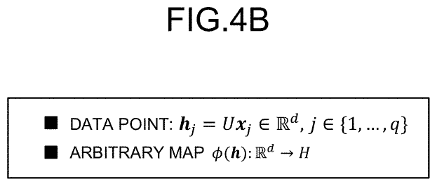

FIG. 3 is a diagram for explaining generation of feature amounts by the feature amount generation unit 12. FIG. 3 illustrates a case in which IP2Vec is used for feature extraction and SVDD is used for anomaly detection. Regarding FIG. 3, FIG. 4A illustrates definitions of symbols for IP2Vec, and FIG. 4B illustrates definitions of symbols for SVDD. In FIG. 4A, a one-hot vector is a vector in which a single 1 is used for only one element and 0s are used for the other elements.

As illustrated in FIG. 3, a neural network (NN) with a single hidden layer is used in IP2Vec. The number of neurons in the input layer is p, the number of neurons in the hidden layer is d, and he number of neurons in the final layer is p. Herein, p represents the total number of patterns of communication information, and, of that number, q represents the number of unique source IP addresses. d represents the number of feature amounts extracted for the source IP addresses. Letting an input is x, an output h from the hidden layer is h=Ux, and an output y from the final layer is y=softmax(U′^{T}h). U′^{T} is a transpose of U′.

In an NN based on IP2Vec, training is conducted using (wᵢ, C(wᵢ)) as training data. In other words, training is conducted so that C(wᵢ) is output in response to an input of wᵢ. The input of wᵢ is provided as a one-hot vector xᵢ in which the number of components is p and the component corresponding to wᵢ is 1. Training is conducted so that, in response to an input of xᵢ an output of a neuron corresponding to w_{c,i} in the final layer is 1. The output of the neuron corresponding to w_{c,i} in the final layer is P(w_{c,i}|wᵢ; U, U′).

In other words, in IP2Vec, U and U′ are calculated so that the posterior probability P(w_{c,i}|wᵢ; U, U′) that, when wᵢ is determined, w_{c,i} co-occur reaches a maximum, and the feature amount vector of the source IP address j is obtained as uⱼ. Consequently, in IP2Vec, by minimizing the loss function defined by expression (1), the posterior probability P(w_{c,i}|wᵢ; U, U′) is maximized, which extracts an optimum feature amount vector.

The feature amount generation unit 12 takes the output h=Ux=u at the hidden layer of IP2Vec as an input to SVDD. In SVDD, h is mapped by the map φ in the space H. The dimension of H is arbitrary. A loss function of SVDD is found in the following expression (3).

$$Expression 3$$

$${L}_{d e t e c t i} , {c}_{0} , r ) = {r}^{2} + c {\sum }_{j} max \{ 0 , {‖ ϕ ( {h}_{j} ) - {c}_{0} ‖}_{2}^{2} - {r}^{2} \} \qquad ( 3 )$$

Herein, r represents a radius of a sphere centering around c₀ in the space H. If the space H is two-dimensional, r is a radius of a circle. If the space H is three-dimensional, r is a radius of a sphere. C represents a coefficient for adjusting a trade-off between the first term and the second term. The first term represents the size of the sphere, and the second term is the sum of squares of the distances from points out of the sphere, of the points of the feature amount vector uⱼ of the source IP address j (j∈{1, . . . , q}) mapped in the space H, to the surface of the sphere. A larger sphere enables the second term to be zero but the first term to be larger, while a smaller sphere enables the first term to be smaller but the second term to be larger with more points out of the sphere.

In SVDD, by minimizing expression (3), r and c₀ are determined so that points of the feature amount vector uⱼ mapped in the space H gather as closer to c₀ as possible. However, the feature amount generation unit 12 minimizes expression (2) as an abbreviated version of expression (3).

In this manner, the feature amount generation unit 12 connects the output hⱼ=Uxⱼ=uⱼ at the hidden layer of IP2Vec to the loss function for anomaly detection, thereby enabling extraction of a feature amount suitable for anomaly detection. The feature amount generation unit 12 uses gradient descent, for example, as an optimization method to minimize the loss function L.

The explanation returns to FIG. 1 now. The anomaly score computation unit 13 computes an anomaly score by using the feature amount generated by the feature amount generation unit 12. The anomaly score computation unit 13 computes an anomaly score Sⱼ by using the following expression (4).

Sⱼ=∥ϕ(hⱼ)−c₀∥₂² (4)

The anomaly determination unit 14 compares the anomaly score Sⱼ with a predetermined threshold, and, if the anomaly score Sⱼ is equal to or greater than the predetermined threshold, detects the source IP address j as an anomaly IP address. The anomaly determination unit 14 decodes the encoded anomaly IP address and displays the address on a display device.

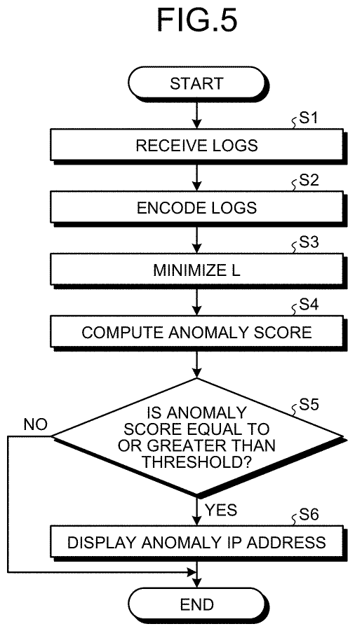

A flow of a process performed by the anomaly detection apparatus 1 will be explained next. FIG. 5 is a flowchart illustrating the flow of a process performed by the anomaly detection apparatus 1. As illustrated in FIG. 5, the anomaly detection apparatus 1 receives logs (step S1). In other words, the anomaly detection apparatus 1 receives the proxy log 3, the IDS log 5, the FW log 7, and the terminal log 9.

The anomaly detection apparatus 1 then encodes the logs (step S2), and minimizes L (step S3). The anomaly detection apparatus 1 then computes the anomaly score for each source IP address (step S4), determines whether the anomaly score is equal to or greater than a threshold (step S5), and, if the anomaly score is equal to or greater than the threshold, displays an anomaly IP address (step S6).

In this manner, the anomaly detection apparatus 1 minimizes a loss function for feature extraction and a loss function for anomaly detection at the same time by minimizing L, which enables extraction of a feature amount suitable for anomaly detection.

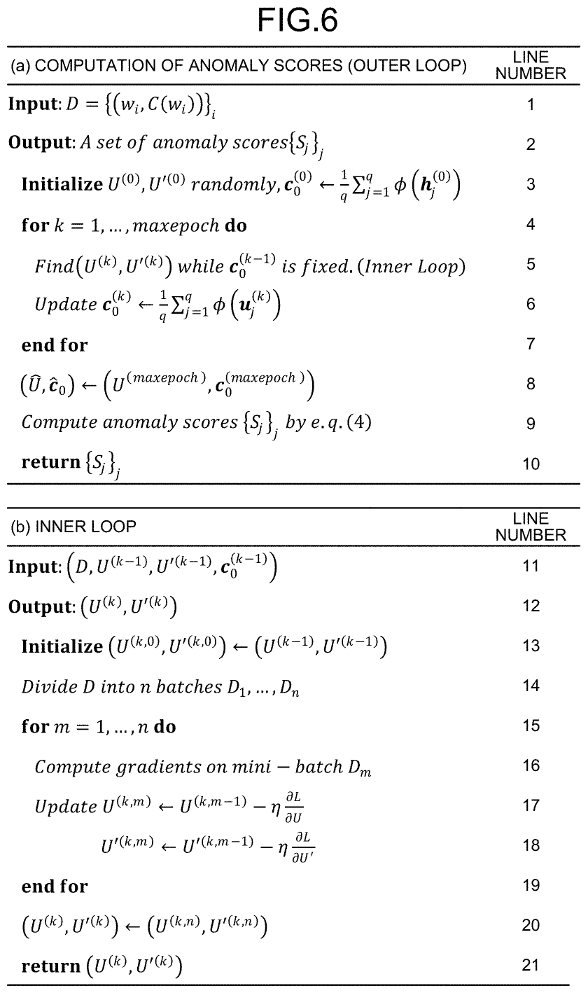

FIG. 6 is a diagram illustrating a flow of a process of computing anomaly scores by generating feature amounts that minimize L. As illustrated in FIG. 6, the flow of the process of computing anomaly scores by generating feature amounts that minimize L is made up of two loops: (a) anomaly score computation (outer loop); and (b) inner loop.

As illustrated in FIG. 6(a), the input of the outer loop is a data set D={(wᵢ, C(wᵢ))}ᵢ (line number 1), and the output is an anomaly score {Sⱼ}ⱼ (line number 2). The anomaly detection apparatus 1 randomly initializes a 0-th generation U and U′, and initializes a 0-th generation c₀ with a mean value of a 0-th generation φ(hⱼ) (line number 3).

The anomaly detection apparatus 1 then computes a first-generation to maximum generation U, U′, and c₀ by performing repeated computation (line numbers 4 to 7), and takes the maximum generation U and c₀ as optimum values (line number 8). The anomaly detection apparatus 1 computes k-th generation U and U′ in the inner loop while fixing a (k−1)-th generation c₀ during the repeated computation (line number 5), and computes a k-th generation c₀ by using the k-th generation U (line number 6). The anomaly detection apparatus 1 computes anomaly scores {Sⱼ}ⱼ by using expression (4) from the optimum values of U and c₀ (line number 9), and returns the anomaly scores {Sⱼ}ⱼ (line number 10).

As illustrated in FIG. 6(b), the input of the inner loop is D and (k−1)-th generation U, U′, and c₀ (line number 11), and the output is the k-th generation U and U′ (line number 12). In the inner loop, the anomaly detection apparatus 1 initializes 0-th batch of the k-th generation U and U′ with the (k−1)-th generation U and U′ (line number 13), and dives D into n mini batches D₁, . . . , Dₙ (line number 14).

The anomaly detection apparatus 1 then computes a first batch to an n-th batch of the k-th generation U and U′ by performing repeated computation (line numbers 15 to 19), and takes the n-th batch of the k-th generation U and U′ as the k-th generation U and U′ (line number 20). The anomaly detection apparatus 1 then returns the k-th generation U and U′ (line number 21).

The anomaly detection apparatus 1 computes a gradient of L with respect to U and a gradient of L with respect to U′ by using a mini batch Dₘ during the repeated computation (line number 16). The anomaly detection apparatus 1 subtracts a value obtained by multiplying the gradient of L with respect to U by η from a (m−1)-th batch of the k-th generation U to compute a m-th batch of the k-th generation U (line number 17). The anomaly detection apparatus 1 also subtracts a value obtained by multiplying the gradient of L with respect to U′ by η from a (m−1)-th batch of the k-th generation U′ to compute a m-th batch of the k-th generation U′ (line number 18).

In this manner, the anomaly detection apparatus 1 repeats a process the number of times of the maximum generation while adding 1 to k one at a time, the process of computing the k-th generation U and U′ by using gradient descent while fixing the (k−1)-th generation c₀ and computing the k-th generation c₀ by using the computed k-th generation U. Consequently, the anomaly detection apparatus 1 can compute U and c₀ that minimize L.

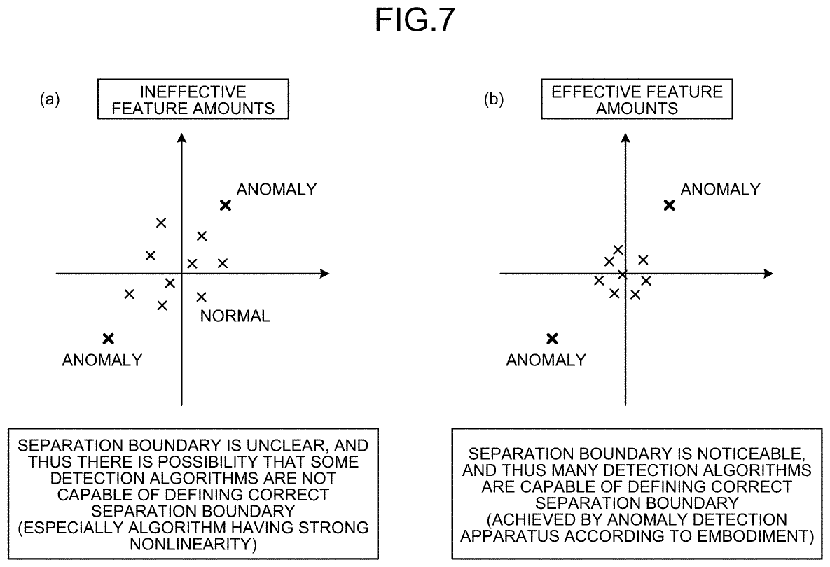

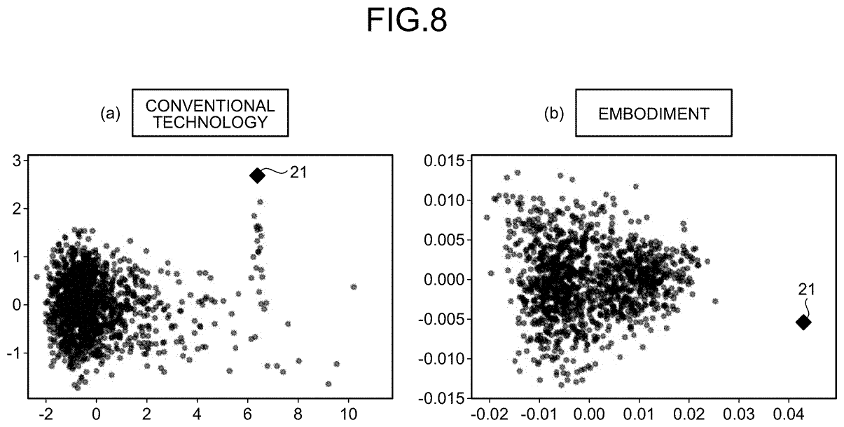

The effect of the anomaly detection apparatus 1 will be explained next with reference to FIG. 7 and FIG. 8. FIG. 7 is a diagram for explaining effective feature amounts generated by the anomaly detection apparatus 1. FIG. 7(a) illustrates ineffective feature amounts, and FIG. 7(b) illustrates effective feature amounts generated by the anomaly detection apparatus 1. FIG. 7 illustrates cases in which the number of feature amounts is two for convenience of explanation.

As illustrated in FIG. 7(a), in the case in which the feature amounts are ineffective, the separation boundary between normal and anomaly is unclear in the feature amount space, and thus there is a possibility that some detection algorithms are not capable of defining a correct separation boundary. There is a possibility that especially an algorithm having strong nonlinearity is not capable of defining a correct separation boundary.

Meanwhile, in the case in which the feature amounts generated by the anomaly detection apparatus 1 are effective, the separation boundary between normal and anomaly is noticeable in the feature amount space, as illustrated in FIG. 7(b), and thus many detection algorithms are capable of defining a correct separation boundary. The anomaly detection apparatus 1 generates a feature amount effective for detection, which can improve the precision of anomaly detection.

FIG. 8 is a diagram illustrating the effect of the anomaly detection apparatus 1. FIG. 8 illustrates a case in which coburg intrusion detection data sets (CIDDS)-001 are used as an example of data sets. The task of this example is to detect an IP address of an attacker from one hundred thousand IDS logs including about four thousand IP addresses as an anomaly IP address. FIG. 8(a) illustrates feature amounts of a conventional technology, and FIG. 8(b) illustrates feature amounts of the embodiment. A point 21 indicates an anomaly IP address, and other points indicate normal IP addresses.

As illustrated in FIG. 8, in the embodiment, the separation boundary between normal and anomaly is noticeable as compared with the conventional technology, and the feature amounts of the embodiment are effective as compared with the feature amounts of the conventional technology. Also, precision (PRC)=0.90 in the embodiment, whereas PRC=0.22 in the conventional technology. Herein, PRC refers to the ratio of being a truly anomaly IP address to IP address that have been determined as anomaly, and being closer to 1 is better. Consequently, the anomaly detection apparatus 1 has higher precision than the conventional technology.

As has been explained above, in the embodiment, the feature amount generation unit 12 generates a feature amount that minimizes the loss function L=L_{extraction}+λL_{detection} and can thus generate a feature amount effective for anomaly detection. Consequently, the anomaly detection apparatus 1 can improve the detection precision.

In the embodiment, the feature amount generation unit 12 connects the output at the hidden layer of the NN based on IP2Vec to L_{detection}, thereby minimizing the loss function L, which can minimize L_{extraction} and L_{detection} at the same time.

In the embodiment, the case has been explained in which IP2Vec is used for feature amount extraction and SVDD is used for anomaly detection. However, the anomaly detection apparatus 1 may use other methods for feature amount extraction and anomaly detection. In the embodiment, the case has been explained in which gradient descent is used for optimization. However, the anomaly detection apparatus 1 may use other methods for optimization. In the embodiment, the case has been explained in which an anomaly IP address is detected. However, the anomaly detection apparatus 1 may detect other abnormal values in categorical data.

While the anomaly detection apparatus 1 has been explained in the embodiment, an anomaly detection program having the same functions can be obtained by achieving the configuration that the anomaly detection apparatus 1 has by means of software. Thus, a computer that executes the anomaly detection program will be explained.

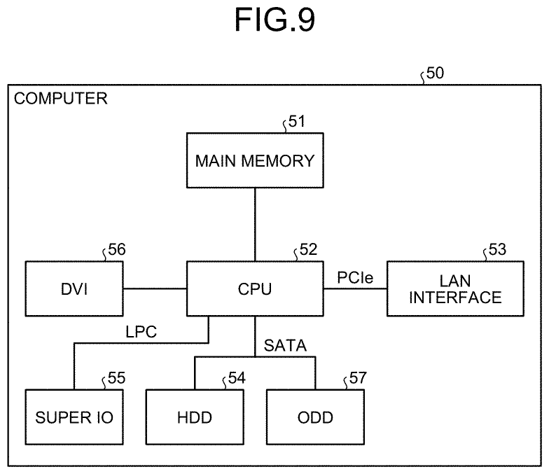

FIG. 9 is a diagram illustrating a hardware configuration of a computer that executes an anomaly detection program according to the embodiment. As illustrated in FIG. 9, a computer 50 has a main memory 51, a central processing unit (CPU) 52, a local area network (LAN) interface 53, and a hard disk drive (HDD) 54. The computer 50 also has a super input/output (IO) 55, a digital visual interface (DVI) 56, and an optical disk drive (ODD) 57.

The main memory 51 is a memory that stores therein computer programs, intermediate results of executing the computer programs, or the like. The CPU 52 is a central processing unit that reads a computer program from the main memory 51 and executes the computer program. The CPU 52 includes a chip set having a memory controller.

The LAN interface 53 is an interface for connecting the computer 50 through a LAN to another computer. The HDD 54 is a disk device that stores therein computer programs and data, and the super IO 55 is an interface for connecting input devices, such as a mouse and a keyboard. The DVI 56 is an interface for connecting a liquid crystal display, and the ODD 57 is a device that reads and writes DVDs and CD-Rs.

The LAN interface 53 is connected to the CPU 52 with PCI Express (PCIe), and the HDD 54 and the ODD 57 are connected to the CPU 52 via serial advanced technology attachment (SATA). The super IO 55 is connected to the CPU 52 via low pin count (LPC).

The anomaly detection program to be executed on the computer 50 is stored in a CD-R, which is an example of a recording medium readable by the computer 50, is read from the CD-R by the ODD 57, and is installed in the computer 50. Alternatively, the anomaly detection program is stored in a database and the like of another computer system connected through the LAN interface 53, is read from such a database, and is installed in the computer 50. The installed anomaly detection program is then stored in the HDD 54, is read into the main memory 51, and is executed by the CPU 52.

In one aspect of an embodiment of the invention, the precision of anomaly detection can be improved.

All examples and conditional language provided herein are intended for the pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing therein an information processing program that causes a computer to execute a process comprising:
identifying feature amounts for respective values in categorical data so as to minimize a third loss function based on a first loss function for extraction of feature amounts in categorical data and a second loss function for detection of abnormal values in the categorical data; and
detecting the abnormal values in the categorical data, based on the feature amounts identified for the respective values in the categorical data, wherein
the categorical data is source IP addresses,
the identifying identifies feature amounts of source IP addresses included in a communication log by using the communication log, and
the detecting detects an anomaly IP address.

2. The non-transitory computer-readable recording medium according to claim 1, wherein the third loss function is a function obtained by adding the first loss function to a function obtained by multiplying the second loss function by a value for adjusting a trade-off between the first loss function and the second loss function.

3. The non-transitory computer-readable recording medium according to claim 1, wherein
the identifying identifies the feature amounts by using IP2Vec, and
the detecting detects the abnormal values by using SVDD.

4. The non-transitory computer-readable recording medium according to claim 3, wherein the identifying connects an output at a hidden layer of a neural network used for identifying the feature amounts to the second loss function to minimize the third loss function.

5. An information processing method comprising:
identifying, using a processor, feature amounts for respective values in categorical data so as to minimize a third loss function based on a first loss function for extraction of feature amounts in categorical data and a second loss function for detection of abnormal values in the categorical data; and
detecting, using the processor, the abnormal values in the categorical data, based on the feature amounts identified for the respective values in the categorical data, wherein
the categorical data is source IP addresses,
the identifying identifies feature amounts of source IP addresses included in a communication log by using the communication log, and
the detecting detects an anomaly IP address.

6. An information processing apparatus comprising:
a memory; and
a processor coupled to the memory and the processor:
identify feature amounts for respective values in categorical data so as to minimize a third loss function based on a first loss function for extraction of feature amounts in categorical data and a second loss function for detection of abnormal values in the categorical data; and
detect the abnormal values in the categorical data, based on the feature amounts identified by the identification unit for the respective values in the categorical data, wherein
the categorical data is source IP addresses,
the identifying identifies feature amounts of source IP addresses included in a communication log by using the communication log, and
the detecting detects an anomaly IP address.
